(19) United States
(12) Patent Application Publication
(10) Pub. No.: US 2006/0026619 A1
(43) Pub. Date: Feb. 2, 2006

(54) Optical disk device

(75) Inventors: Takeshi Makino, Takefu-city (JP); Hirotoshi Hara, (US)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/188,852

(22) Filed: Jul. 26, 2005

(30) Foreign Application Priority Data
Jul. 28, 2004 (JP) 2004-219835

(51) Int. Cl. G11B 7/08

(52) U.S. Cl. 720/658

(57) ABSTRACT

The invention provides an optical disk device capable of preventing noise from being generated when removing the optical disk from a clamp portion clamping the optical disk. The optical disk 2 is fixed horizontally on a clamp portion 4 of a turntable 3 capable of being moved in an arc. A mounting surface 10A of a tray 10 on which the optical disk 2 is placed is inclined. Thereby, when the optical disk 2 is moved in an arc and pressed onto the tray 10 to be detached from the clamp portion 4, the mounting surface 10A is inclined so that the optical disk maintains contact with the mounting surface 10A of the tray when being detached from the clamp portion 4, by which the generation of noise caused by the optical disk 2 being lifted from the tray 10 and falling on the tray 10 by its own weight can be prevented.

The present application is based on and claims priority of Japanese patent application No. 2004-219835 filed on Jul. 28, 2004, the entire contents of which are hereby incorporated by reference.

### BACKGROUND OF THE INVENTION

1. Field of the Invention

The present invention relates to an optical disk device for reproducing data on an optical disk (recording medium), and more specifically, to an optical disk device with a tray for mounting the optical disk having an inclined mounting surface so as to prevent the generation of noise caused by the optical disk being detached from a clamp portion fixing the optical disk and falling onto the tray.

2. Description of the Related Art

Heretofore, electronic devices such as optical disk devices for reproducing images or audios recorded on optical disks such as DVDs (digital versatile disks) and CDs (compact disks) are generally designed to reproduce the image or audio on the optical disk by placing the optical disk on a tray, moving the optical disk above the tray, engaging the hole on the center of the optical disk to a clamper provided on a turntable, rotating the optical disk fixed to the turntable via a motor, and moving a pickup along the radial direction of the optical disk. In such an optical disk device, upon removing the optical disk from the optical disk device after use, at first the optical disk 100 is at a reproducible state (rotatable state) as shown in FIG. 7(a), so in order to detach the optical disk 100 from the clamp portion 101, the optical disk 100 is moved downward so that one end A in the circumference of the optical disk 100 contacts the tray 102 (FIG. 7(b)), then the optical disk 100 is pressed further toward the tray 102 so that the optical disk 100 is detached from the clamp portion 101 (FIG. 7(c)). In such an optical disk device 103, the mounting surface 104 of the tray 102 for placing the optical disk 100 is generally horizontal, and when one end A of the optical disk 100 is pressed against the tray 102, the optical disk 100 is detached from the clamp portion 101 on the turntable 106 to which the mounting hole 105 of the optical disk 100 is engaged. In this case, as shown in FIG. 7(c), a movable device not shown arranged as a traverse moves the fixed optical disk 100 downward in an arc together with the turntable 106 to detach the optical disk 100 from the clamp portion 101. Further, Japanese Patent Application Laid-Open Publication No. 2003-45104 (patent document 1) discloses an optical disk device capable of clamping the optical disk securely on the turntable of the optical disk device having a slot-in mechanism.

According to the above-mentioned prior art, in order to remove the optical disk from the turntable when the optical disk is at a reproducible (rotatable) state, the turntable is moved downward in an arc, so that when one end of the circumference of the optical disk comes into contact with the tray, the other end of the diameter of the optical disk is raised from the mounting surface of the tray with a space formed under the disk. In this state, the turntable is further lowered in an arc to detach the optical disk from the clamp portion, by which the other end of the optical disk falls onto the mounting surface of the tray by its own weight, and the rebound of the raised end of the optical disk falling onto the tray causes the first end and the opposite end to bounce up and down on the mounting surface of the tray. Thus, the optical disk is moved wildly in the device, and the noise caused by the movement of the optical disk on the mounting surface of the tray deteriorates the quality of the device.

### SUMMARY OF THE INVENTION

The present invention aims at solving the problems of the prior art, by providing an optical disk device capable of preventing the generation of noise caused by the fall or wild movement of the optical disk being detached from the clamp portion on which the disk is fixed.

A first aspect of the present invention relates to an optical disk device comprising a turntable having a contact surface on which an optical disk is horizontally placed; a clamp portion for fixing the optical disk placed on the turntable; a rotary drive unit for rotating the optical disk fixed to the clamp portion together with the turntable; a tray for placing the optical disk when attaching the optical disk to or detaching the same from the clamp portion; and a movable member moving in an arc for pressing the optical disk onto the tray and detaching the disk from the clamp portion; wherein the tray has a mounting surface for mounting the optical disk that is inclined so that the optical disk maintains contact with the mounting surface of the tray when being detached from the clamp portion.

According to the first aspect of the invention, the mounting surface of the tray for mounting the optical disk is inclined with respect to the optical disk fixed horizontally on the clamp portion, so that when the optical disk is moved downward in an arc by the movable member and pressed against the tray to be detached from the clamp portion of the turntable, the optical disk maintains contact with the mounting surface of the tray while being detached from the clamp portion, so that the prior art problem of noise caused by one end of the optical disk being raised above the tray and falling onto the tray when being detached from the clamp portion can be solved, even with the optical disk moved in an arc.

A second aspect of the present invention relates to the optical disk device according to the first aspect, wherein the mounting surface of the tray is inclined within the range of 0.2 degrees through 3 degrees with respect to the optical disk being fixed horizontally on the clamp portion.

According to the arrangement of the second aspect, the mounting surface of the tray is inclined within the range of 0.2 degrees through 3 degrees with respect to the optical disk being fixed horizontally on the clamp portion, so that when the optical disk being moved in an arc by the movable member is pressed onto the tray to be detached from the clamp portion of the turntable, the optical disk can maintain contact with the mounting surface of the tray throughout the removal from the clamp portion, and the problem of noise caused by the optical disk falling onto the tray by its own weight can be prevented without fail.

### BRIEF DESCRIPTION OF THE DRAWINGS

FIG. 1 is a cross-sectional view showing the schematic structure of an optical disk device according to the present invention;

FIG. 2 is a cross-sectional view showing the operation of the optical disk device according to the present invention;

FIG. 3 is a plan view showing the optical disk according to the present invention;

FIG. 4 is a plan view showing the measurement points of the optical disk according to the present invention;

FIG. 5 is a cross-sectional view showing the tray according to the present invention;

FIG. 6 is a cross-sectional view showing the measurement points of the optical disk according to the present invention; and

FIG. 7 is a cross-sectional view showing the operation of an optical disk device according to the prior art.

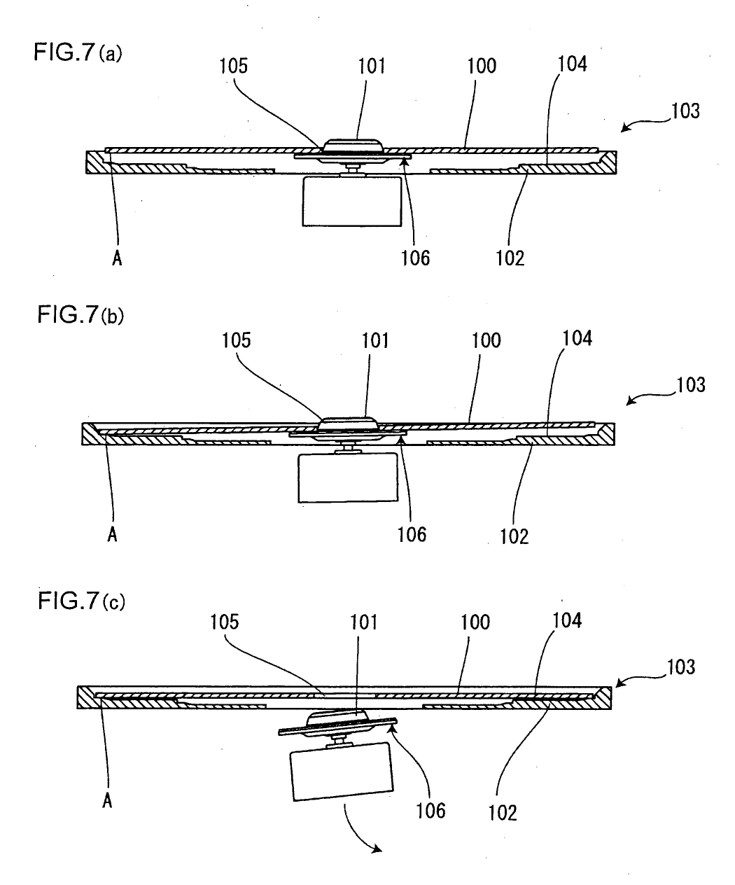

### DETAILED DESCRIPTION OF THE PREFERRED EMBODIMENTS

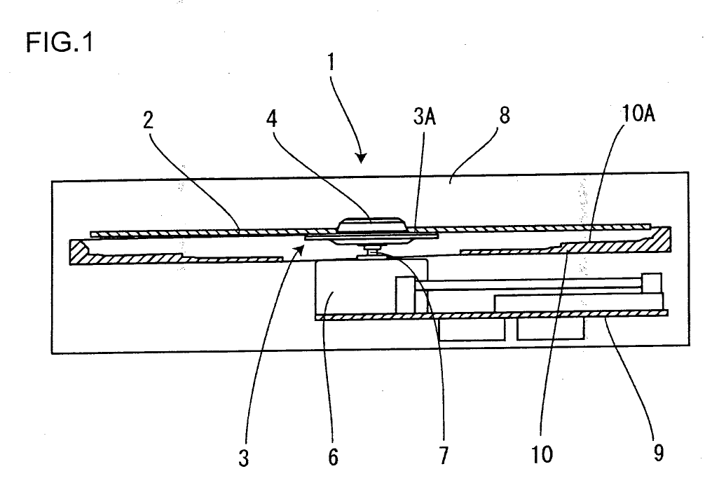

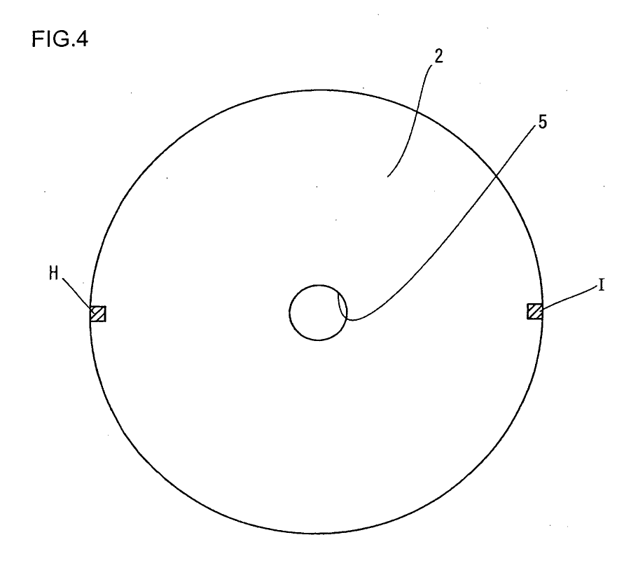

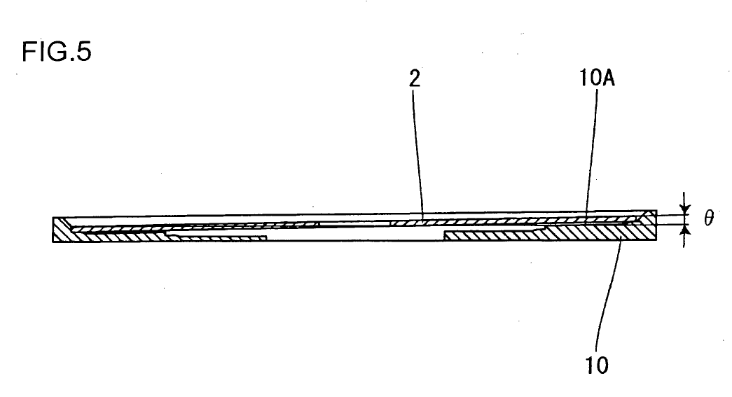

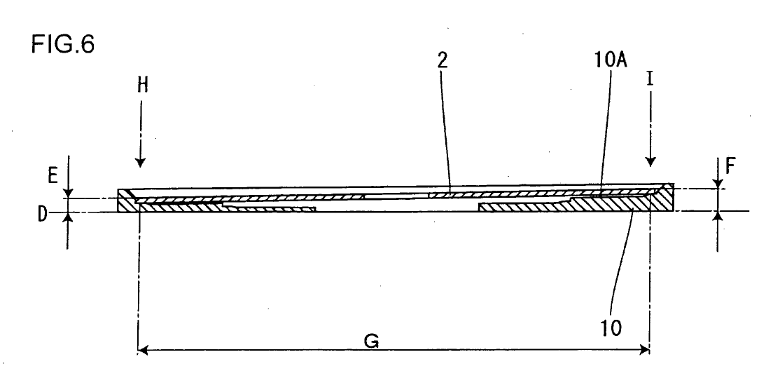

Now, the preferred embodiments for carrying out the present invention will be described with reference to FIGS. 1 through 6. The technical scope of the present invention is not restricted to the language used in the embodiments, but is extended to the range in which a person skilled in the art could easily substitute based on the present disclosure.

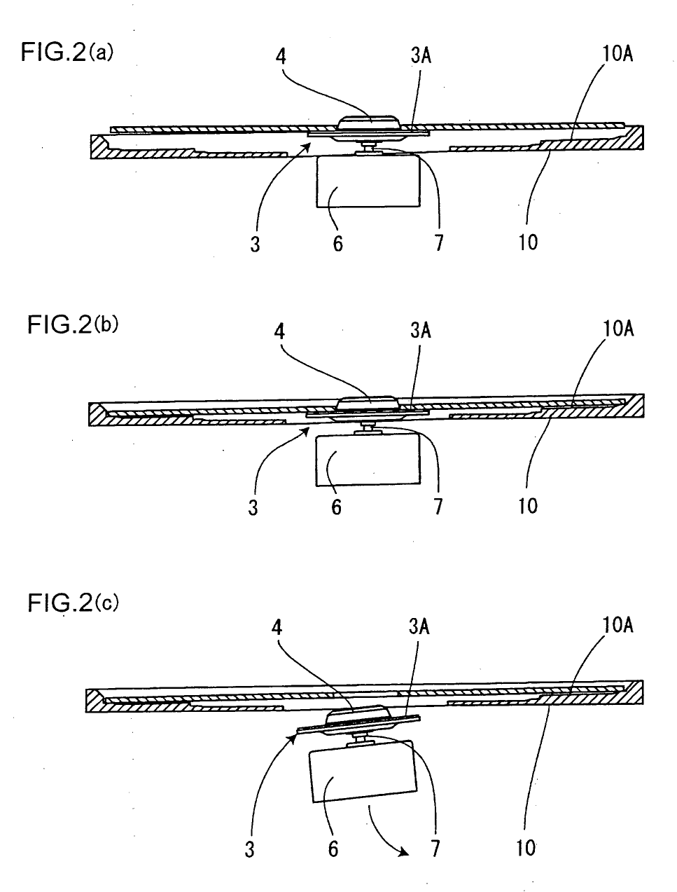

FIG. 1 is a side view showing the schematic structure of an optical disk device, which is an electronic device according to the present invention. As illustrated, the optical disk device 1 is equipped with a turntable 3 to which the optical disk 2 is mounted. This turntable 3 will be described in detail. The turntable 3 has a clamp portion 4 formed integrally thereto, and a mounting hole 5 provided on the center of the round optical disk 2 is engaged in removable manner to the clamp portion 4. As illustrated in FIG. 2(a), in a state where the optical disk is horizontally attached to the clamp portion 4, the optical disk 2 is rotated together with the turntable 3 to record or reproduce data on the disk.

Reference number 6 denotes a motor, which is a rotary drive unit for rotating the turntable 3, having a rotary shaft 7 to which the turntable 3 is fixed so that the motor 6 can rotate the turntable 3.

Further, from the state shown in FIG. 2(a) where the turntable 3 is elevated, the turntable 3 is moved downward toward the lower side of the tray 10 together with the motor 6 by a movable member 9 disposed inside a casing 8 of the optical disk device 1. The movable member 9 is arranged as a so-called traverse unit, having one end thereof screw-engaged to the casing 8, moving the turntable 3 together with the motor 6 toward the lower side of the tray 10 in an arc (toward the direction shown by the arrow in FIG. 2(c)) with the screw-engaged portion functioning as a supporting point.

Furthermore, as shown in FIG. 2(a), the mounting surface 10A of the upper surface of the tray 10 on which the optical disk 2 is placed is inclined, the angle θ thereof being 1 degree, with respect to the optical disk 2 attached to the clamp portion 4 and horizontally disposed or to a horizontal contact surface 3A of the turntable 3 to which the optical disk 2 is in contact with when engaged with the clamp portion 4. As shown in FIG. 2, the positional relationship between the mounting surface 10A of the tray 10 and the horizontal contact surface 3A of the turntable 3 moved downward in an arc or the horizontally disposed optical disk 2 is set so that when the optical disk 2 is horizontally fixed to the clamp portion 4 and the turntable 3 is moved downward in an arc (not in the perpendicular direction), the direction of incline of the tray 10 is formed so that the side of the mounting surface 10A of the tray 10 on which a portion of the optical disk 2 initially contacts by the movement of the turntable 3 is set lower than the opposite side of the diameter of the optical disk 2, and the angle θ of the mounting surface 10A of the upper surface of the tray 10 on which the optical disk 2 is placed with respect to the position of the horizontally arranged optical disk 2 in the reproducible condition is preferably within the range of 0.2°=θ=3°, and more preferably, within the range of 0.5°=θ=2°, and most preferably, θ=1°. According to this arrangement, upon removing the optical disk 2 from the clamp portion 4, the optical disk 2 can be removed from the clamp portion 4 while being placed on the mounting surface 10A of the tray 10, and the occurrence of noise caused by the optical disk 2 falling on the tray 10 by its own weight can be prevented. The present invention also enables to prevent the occurrence of noise generated in the conventional device caused by having only one end of the circumference of the optical disk coming into contact with the tray when the optical disk is detached from the clamp portion of the turntable and having the other end in the diameter of the disk being raised from the mounting surface of the tray, according to which the optical disk falls on the mounting surface of the tray by its own weight and is bounced by the rebound at the other end of the optical disk falling on the tray, by which the disk moves wildly in the device generating noise.

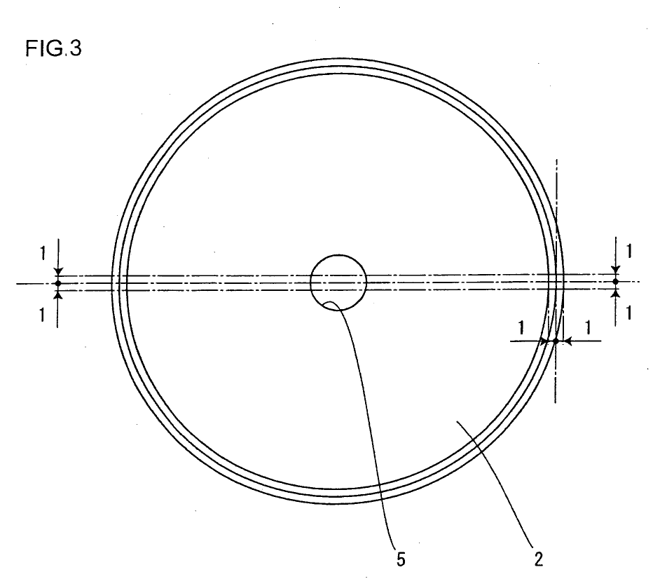

Further, the angle θ can be computed by the following formula 1. When the disk 2 is secured horizontally on the clamp portion 4 and the lower surface of the tray 10 is arranged horizontally, measurement points H and I on the upper surface of the optical disk 2 at both ends on the diameter thereof are set within a range surrounded by a square, each edge of the square being approximately 2 mm, as shown in FIG. 3, and the lower surface of the tray 10 is set as a reference surface D, then the heights E and F from the reference surface D to the optical disk 2 on the mounting surface 10A of the tray 10 and the distance G between the measurement points H and I are measured using a noncontact measuring machine with the optical disk 2 placed on the tray 10. The angle θ can be calculated using these measurement values E, F and G by the following formula 1.
θ=tan⁻θ((F−E)/G) [Formula 1]

As described, according to the above arrangement, the optical disk device 1 comprises a turntable 3 having a contact surface on which an optical disk 2 is horizontally placed, a clamp portion 4 for fixing the optical disk 2 placed on the turntable 3, a motor 6 functioning as a rotary drive unit for rotating the optical disk 2 fixed by the clamp portion 4 together with the turntable 3, a tray 10 for placing the optical disk 2 when attaching the optical disk 2 or detaching the same from the clamp portion 4, and a movable member 9 moving downward in an arc for pressing the optical disk 2 onto the tray 10 and detaching the disk from the clamp portion 4, wherein the mounting surface 10A of the tray 10 on which the optical disk 2 is placed is inclined so as to enable the optical disk 2 to be detached from the clamp portion 4 while maintaining contact with the mounting surface 10A of the tray 10 upon detaching the optical disk 2 from the clamp portion 4, and especially, the mounting surface 10A of the tray 10 is inclined within the range of 0.2 degrees through 3 degrees with respect to the optical disk 2 fixed horizontally on the clamp portion 4. According to this arrangement, the mounting surface 10A of the tray 10 on which the optical disk 2 is placed is inclined with respect to the optical disk 2 fixed horizontally on the clamp portion 4, so that when the optical disk 2 is moved downward in an arc by the movable member 9 and pressed onto the tray 10 to be detached from the clamp portion 4 on the turntable 3, the optical disk 2 is removed from the clamp portion 4 while constantly maintaining contact with the mounting surface 10A of the tray 10 on which the disk 2 is placed. Therefore, the present invention provides an optical disk device 1 solving the prior art problem of the optical disk moved in an arc having one end thereof raised from the tray upon detaching the optical disk from the clamp portion, according to which a space is formed between the disk and tray and noise is generated by the optical disk 2 falling onto the tray 10 by its own weight.

The effects of the present invention are as follows.

According to the first aspect of the present invention, the optical disk device comprises a turntable having a contact surface on which an optical disk is horizontally placed; a clamp portion for fixing the optical disk placed on the turntable; a rotary drive unit for rotating the optical disk fixed to the clamp portion together with the turntable; a tray for placing the optical disk when attaching the optical disk to or detaching the same from the clamp portion; and a movable member moving in an arc for pressing the optical disk onto the tray and detaching the disk from the clamp portion; wherein the tray has a mounting surface for mounting the optical disk that is inclined so that the optical disk maintains contact with the mounting surface of the tray when being detached from the clamp portion. According to the present arrangement, the optical disk device can suppress the noise caused when detaching the optical disk from the clamp portion.

According to the second aspect of the present invention, the optical disk device according to the first aspect of the invention characterizes in that the mounting surface of the tray is inclined within the range of 0.2 degrees through 3 degrees with respect to the optical disk being fixed horizontally on the clamp portion. According to the present arrangement, the optical disk device can suppress the noise caused when detaching the optical disk from the clamp portion.

What is claimed is:

1. An optical disk device comprising:
a turntable having a contact surface on which an optical disk is horizontally placed;
a clamp portion for fixing the optical disk placed on the turntable;
a rotary drive unit for rotating the optical disk fixed to the clamp portion together with the turntable;
a tray for placing the optical disk when attaching the optical disk to or detaching the same from the clamp portion; and
a movable member moving in an arc for pressing the optical disk onto the tray and detaching the disk from the clamp portion;
wherein the tray has a mounting surface for mounting the optical disk that is inclined so that the optical disk maintains contact with the mounting surface of the tray while being detached from the clamp portion.

2. The optical disk device according to claim 1, wherein the mounting surface of the tray is inclined within the range of 0.2 degrees through 3 degrees with respect to the optical disk being fixed horizontally on the clamp portion.
